(19) United States
(12) Patent Application Publication
(10) Pub. No.: US 2026/0186208 A1
(43) Pub. Date: Jul. 2, 2026

(54) FUSION SPLICING METHOD FOR OPTICAL FIBERS AND FUSION SPLICING DEVICE FOR OPTICAL FIBERS

(71) Applicant: Sumitomo Electric Optifrontier Co., Ltd., Yokohama-shi, Kanagawa (JP)

(72) Inventors: Tomoyoshi SASAKI, Yokohama-shi, Kanagawa (JP); Kazufumi JOKO, Yokohama-shi, Kanagawa (JP); Ryuichiro SATO, Yokohama-shi, Kanagawa (JP); Hiroshi SADAKI, Yokohama-shi, Kanagawa (JP)

(21) Appl. No.: 18/703,775

(22) PCT Filed: Nov. 9, 2022
(86) PCT No.: PCT/JP2022/041759

§ 371 Date: Mar. 16, 2026

(30) Foreign Application Priority Data
Nov. 11, 2021 (JP) 2021-183914

(51) Int. Cl. G02B 6/255

(52) U.S. Cl. CPC G02B 6/2551; G02B 6/2553; G02B 6/2556

(57) ABSTRACT

A fusion splicing method includes a step of exposing a glass fiber in a distal end region of an optical fiber strand, a step of disposing the optical fiber strand in a V-shaped groove, a step of pressing the optical fiber strand disposed in the V-shaped groove against the V-shaped groove by a clamp, and a step of causing the optical fiber strand to slide on the V-shaped groove. In the step of disposing the optical fiber strand in the V-shaped groove, a region of the coating portion that is not removed in the optical fiber strand is disposed in the V-shaped groove.

### TECHNICAL FIELD

The present disclosure relates to a fusion splicing method for an optical fiber and a fusion splicing device for an optical fiber.

The present application claims priority to Japanese Patent Application No. 2021-183914 filed on Nov. 11, 2021, and the entire contents of the Japanese patent application are incorporated herein by reference.

### BACKGROUND ART

Patent Literature 1 discloses a fusion splicing device for an optical fiber. In this fusion splicing device, optical fiber strands disposed in a V-shaped groove of a holder are held by a clamp. A coating portion between distal ends of the optical fiber strands is removed. The holder and the clamp are movable by a drive system. The optical fiber strands are aligned with each other and fusion-spliced in a state of being held by the holder and the clamp.

### CITATION LIST

### Patent Literature

Patent Literature 1: International Publication WO 2002/004998

### SUMMARY OF INVENTION

A fusion splicing method according to an aspect of the present disclosure is a method for fusion-splicing, with another optical fiber, an optical fiber strand in which an outer periphery of a glass fiber is coated with a coating portion. This method includes a step of exposing the glass fiber in a distal end region of the optical fiber strand by removing the coating portion in the distal end region, a step of disposing the optical fiber strand in a first V-shaped groove such that an end surface of the exposed glass fiber in the distal end region faces an end surface of a glass fiber included in the other optical fiber, a step of pressing the optical fiber strand disposed in the first V-shaped groove against the first V-shaped groove by a clamp, a step of changing an interval between the end surface of the glass fiber in the distal end region of the optical fiber strand pressed against the first V-shaped groove by the clamp and the end surface of the glass fiber included in the other optical fiber, and a step of fusion-splicing the end surfaces. In the step of disposing the optical fiber strand in the first V-shaped groove, a region of the coating portion that is not removed in the optical fiber strand is disposed in the first V-shaped groove, and in the step of changing the interval between the end surfaces, the optical fiber strand slides on the first V-shaped groove.

### BRIEF DESCRIPTION OF DRAWINGS

FIG. 1 is a diagram for describing an outline of a fusion splicing device as an example.

FIG. 2 is a sectional view for describing a V-shaped groove in the fusion splicing device as an example.

FIG. 3 is a flowchart illustrating a flow of a fusion splicing method as an example.

### DESCRIPTION OF EMBODIMENTS

### Problems to be Solved by Present Disclosure

In a case where alignment is performed by moving a holder and a clamp together with an optical fiber strand, a length of a glass fiber exposed at a distal end of the optical fiber strand can be shortened. On the other hand, since a drive system for moving the holder and the clamp together with the optical fiber strand is required, manufacturing cost of a device increases.

An object of the present disclosure is to provide a fusion splicing method for an optical fiber and a fusion splicing device for an optical fiber capable of shortening a length of a glass fiber to be exposed while reducing manufacturing cost of a device.

### Effects of Present Disclosure

According to the present disclosure, it is possible to provide the fusion splicing method for an optical fiber and the fusion splicing device for an optical fiber capable of reducing the length of the glass fiber to be exposed while reducing the manufacturing cost of the device.

### DESCRIPTION OF EMBODIMENT OF PRESENT DISCLOSURE

First, an embodiment of the present disclosure will be listed and described. A fusion splicing method according to an aspect of the present disclosure is a method for fusion-splicing, with another optical fiber, an optical fiber strand in which an outer periphery of a glass fiber is coated with a coating portion. This method includes a step of exposing the glass fiber in a distal end region of the optical fiber strand by removing the coating portion in the distal end region, a step of disposing the optical fiber strand in a first V-shaped groove such that an end surface of the exposed glass fiber in the distal end region faces an end surface of a glass fiber included in the other optical fiber, a step of pressing the optical fiber strand disposed in the first V-shaped groove against the first V-shaped groove by a clamp, a step of changing an interval between the end surface of the glass fiber in the distal end region of the optical fiber strand pressed against the first V-shaped groove by the clamp and the end surface of the glass fiber included in the other optical fiber, and a step of fusion-splicing the end surfaces. In the step of disposing the optical fiber strand in the first V-shaped groove, a region of the coating portion that is not removed in the optical fiber strand is disposed in the first V-shaped groove, and in the step of changing the interval between the end surfaces, the optical fiber strand slides on the first V-shaped groove.

A fusion splicing device according to another aspect of the present disclosure is a fusion splicing device for an optical fiber for fusion-splicing, with another optical fiber, an optical fiber strand in which an outer periphery of a glass fiber is covered with a coating portion. This device includes a first V-shaped groove in which the optical fiber strand is disposed, a second V-shaped groove in which a glass fiber included in the other optical fiber or the other optical fiber is disposed, a clamp configured to press the optical fiber strand disposed in the first V-shaped groove against a groove bottom side, and a stage configured to move at least one of the optical fiber strand or the other optical fiber such that an interval between an end surface of the glass fiber of the optical fiber strand pressed against the first V-shaped groove by the clamp and an end surface of the glass fiber included in the other optical fiber disposed in the second V-shaped groove or an end surface of the glass fiber disposed in the second V-shaped groove is changed. The optical fiber strand pressed against the first V-shaped groove by the clamp is movable to slide on the first V-shaped groove.

In the fusion splicing method and the fusion splicing device described above, a region of the coating portion in the exposed optical fiber strand from which the glass fiber in the distal end region is exposed is disposed in the first V-shaped groove, and the optical fiber strand is moved in an axial direction by sliding the coating portion on the first V-shaped groove. Accordingly, the length of the exposed glass fiber can be shortened as compared with a case where the exposed glass fiber in the optical fiber strand is disposed in the V-shaped groove and slides. In addition, since it is not necessary to integrally move the first V-shaped groove and the clamp together with the optical fiber strand, the manufacturing cost of the device can be suppressed.

In an example, a depth of the first V-shaped groove may be set to 0.09 mm or more and 0.30 mm or less. In this configuration, in a case where a diameter of the optical fiber strand is about 0.1 mm to about 0.25 mm, the optical fiber strand is easily disposed on the first V-shaped groove such that an inclined surface constituting the first V-shaped groove is a tangential plane of an outer peripheral surface of the optical fiber strand, and the optical fiber strand is prevented from being caught on an upper end of the first V-shaped groove. In addition, since an outer periphery of the optical fiber strand protrudes from the inclined surface constituting the first V-shaped groove, the optical fiber strand can be reliably pressed by the clamp.

A distance between the first V-shaped groove and a second V-shaped groove in which the glass fiber included in the other optical fiber or the other optical fiber is disposed may be set to 8 mm or more. With this configuration, breakage of the coating portion due to arc discharge is suppressed.

In the step of pressing the optical fiber strand against the first V-shaped groove, a force for pressing the optical fiber strand by the clamp may be 14 gf or less. In this configuration, friction generated between the optical fiber strand and the first V-shaped groove can be reduced.

### Details of Embodiment of Present Disclosure

Specific examples of a fusion splicing device and a fusion splicing method according to an embodiment of the present disclosure will be described below with reference to the drawings. It should be noted that the present invention is not limited to these examples, is described by the claims, and is intended to include meanings equivalent to the claims and all changes within the scope of the claims. In the following description, the same elements are denoted by the same reference numerals in the description of the drawings, and redundant description will be omitted. Note that, in the drawings, an XYZ orthogonal coordinate system may be illustrated for easy understanding.

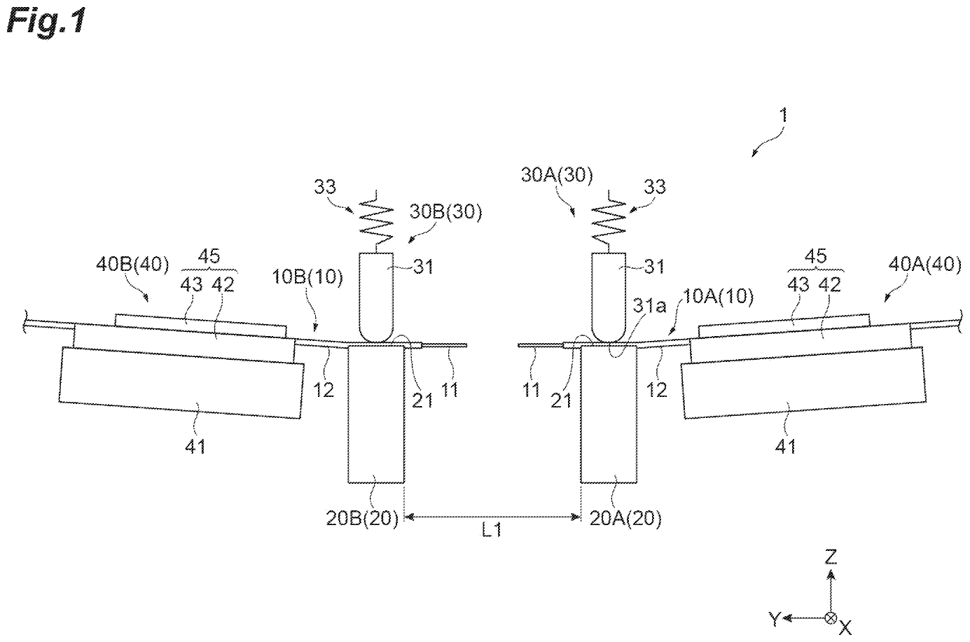

FIG. 1 is a diagram for describing an outline of a fusion splicing device 1 according to an aspect of the present disclosure. As illustrated in FIG. 1, the fusion splicing device 1 includes bases 20, clamps 30, and stages 40. The fusion splicing device 1 is a device that fusion-splices a pair of optical fiber strands 10A and 10B. The optical fiber strand 10 (10A or 10B) includes a glass fiber (bare fiber) 11 and a coating portion 12. The glass fiber 11 is made of quartz glass or the like. The glass fiber 11 has a core and cladding. The coating portion 12 is a portion that coats an outer periphery of the glass fiber 11. The coating portion 12 may be composed of a single layer or multiple layers. In an example, a material forming the coating portion 12 includes an ultraviolet curable resin, a non-halogen resin, a polyester elastomer resin, and the like.

The base 20 has a V-shaped groove 22 for disposing the optical fiber strand 10. The fusion splicing device 1 as an example includes a pair of bases 20A and 20B. Each of the pair of optical fiber strands 10A and 10B is positioned by the V-shaped groove 22 provided in each of the pair of bases 20A and 20B. The base 20 as an example has an upper end surface 21. The V-shaped groove 22 is formed in the upper end surface 21. The upper end surface 21 in the illustrated example is formed flat along an XY plane. The V-shaped groove 22 is linearly formed along a direction in which the pair of bases 20A and 20B faces each other. The V-shaped groove 22 in the illustrated example is formed along a Y direction.

In a case where the optical fiber strand 10 is disposed in the V-shaped groove 22 of the base 20, the coating portion 12 is removed in a distal end region of the optical fiber strand 10, and the glass fiber 11 is exposed. On the other hand, a region of the coating portion 12 which is not removed in the optical fiber strands 10 is disposed in the V-shaped groove 22 of the base 20. That is, the coating portion 12 constituting the optical fiber strands 10 is disposed over the entire region in the Y direction on the V-shaped groove 22. In this case, the glass fiber 11 exposed from the coating portion 12 in the distal end region of the optical fiber strand 10 is not in contact with the V-shaped groove 22. On a pair of V-shaped grooves 22, the pair of optical fiber strands 10A and 10B is disposed such that the exposed glass fibers 11 in the distal end regions face each other.

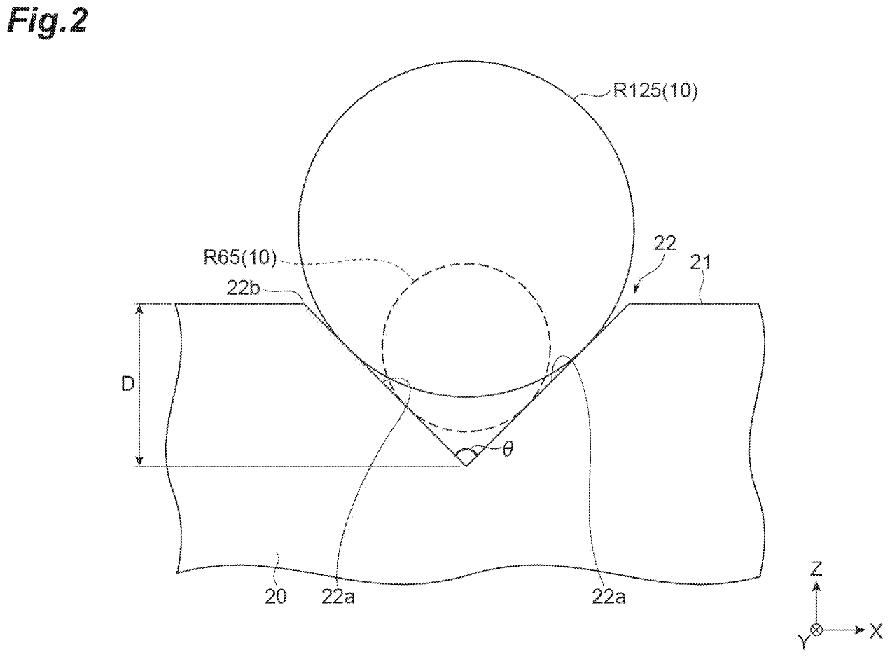

As illustrated in FIG. 2, the V-shaped groove 22 as an example is formed in a V-shaped section by a pair of inclined surfaces 22a. As an example, an angle of the V-shaped groove 22, that is, an angle θ between the pair of inclined surfaces 22a may be about 60 degrees to 120 degrees, but is not particularly limited. Note that, a groove bottom which is a connection portion between the pair of inclined surfaces 22a may have, for example, a curved shape.

A depth D from an upper end of the V-shaped groove 22 to the groove bottom where the inclined surfaces 22a are connected to each other may be set in accordance with an opening angle θ (degrees) between the inclined surfaces 22a and a size of the coating portion 12 of the optical fiber strand 10 to be disposed. In an example, in a case where a radius of the outer periphery of the coating portion 12 is R, an upper limit D1 of the depth of the V-shaped groove 22 may be defined as follows.

$$D 1 = \frac{R}{sin ( θ / 2 )} + R \qquad [ Math . 1 ]$$

A lower limit D2 of the depth may be defined as follows.

$$D 2 = \frac{R}{tan ( θ / 2 )} \times cos ( θ / 2 ) \qquad [ Math . 2 ]$$

In a case where the depth D of the V-shaped groove 22 is determined according to the above two equations, that is, in a case where D2<D<D1, in the optical fiber strand 10 disposed in the V-shaped groove 22, the inclined surface 22a constituting the V-shaped groove 22 is in contact with an outer peripheral surface of the coating portion 12 to be a tangent plane, and a peripheral surface of the coating portion 12 on a side opposite to a peripheral surface facing the groove bottom of the V-shaped groove 22 protrudes from the V-shaped groove 22. In a case where the inclined surface 22a of the V-shaped groove 22 is in contact with the coating portion 12 of the optical fiber strand 10 to be a tangential plane of the coating portion, the coating portion 12 is not in contact with a corner portion 22b at the upper end of the V-shaped groove 22.

For example, in a case where the angle of the V-shaped groove 22 is 90 degrees, the depth of the V-shaped groove 22 is set to approximately 0.09 mm or more and 0.30 mm or less in order to correspond to an optical fiber strand R125 in which a radius R of the coating portion 12 is 0.125 mm. In addition, in a case where the angle of the V-shaped groove 22 is 90 degrees, the depth of the V-shaped groove 22 is set to approximately 0.045 mm or more and 0.150 mm or less in order to correspond to an optical fiber strand R65 in which the radius R of the coating portion 12 is 0.065 mm. In the example illustrated in FIG. 2, the angle of the V-shaped groove 22 is 90 degrees, and the depth D of the V-shaped groove 22 is about 0.12 mm. That is, the depth of the V-shaped groove 22 is set between a lower limit of the depth corresponding to the optical fiber strand R125 having the large radius R of the coating portion 12 and an upper limit of the depth corresponding to the optical fiber strand R65 having the small radius R of the coating portion 12. In this case, even though any of the optical fiber strand R125 and the optical fiber strand R65 is disposed in the V-shaped groove 22, the inclined surface 22a constituting the V-shaped groove 22 is in contact with the outer peripheral surface of the coating portion 12 to be the tangent plane, and the peripheral surface of the coating portion 12 on the side opposite to the peripheral surface facing the groove bottom of the V-shaped groove 22 protrudes from the V-shaped groove 22.

A distance L1 (see FIG. 1) between the V-shaped grooves 22 in which the pair of optical fiber strands 10A and 10B is disposed is set such that the coating portion 12 of the optical fiber strand 10 is not influenced when fusion splicing by arc discharge is performed. As described above, the region of the coating portion 12 of the optical fiber strand 10 is disposed in the V-shaped groove 22. Thus, a distance (that is, a length of the exposed glass fiber 11) from the exposed distal end of the glass fiber 11 to the distal end of the coating portion 12 in the optical fiber strand 10 is limited to half or less of the distance between the pair of V-shaped grooves 22. In this case, when the distance L1 between the pair of V-shaped grooves 22 is too short, it is considered that the coating portion 12 is melted by influence of arc discharge. In an example, the distance L1 between the V-shaped grooves 22 in which the pair of optical fiber strands 10A and 10B is disposed may be set to about 8 mm or more.

Each of the bases 20 (20A and 20B) as an example is configured to be movable in a direction intersecting an axial direction (Y direction) of the optical fiber strand 10. That is, each of the bases 20 can adjust a position of the V-shaped groove 22 in the direction intersecting the axial direction of the optical fiber strand 10. For example, the bases 20A and 20B may be movable in directions intersecting each other. In an example, the base 20A may be movable in an X direction, and the base 20B may be movable in a Z direction. That is, the base 20A may include a drive system for adjusting a position in the X direction, and the base 20B may include a drive system for adjusting a position in the Z direction. Alternatively, both the bases 20A and 20B may include a drive system for adjusting the positions in the X direction and the Z direction, respectively. Each of the stages 40 (40A and 40B) is movable in the Y direction, and may further include a drive system for adjusting a position in each of the X direction and the Z direction. A drive device for integrally moving all the holder (stage) to which the optical fiber strand is fixed, the V-shaped groove, and the clamp in the Y direction may be omitted.

The pair of clamps 30 (30A and 30B) presses the optical fiber strands 10 disposed in the pair of V-shaped grooves 22 against the groove bottom side. The clamp 30 as an example includes a clamp body 31 and a biasing member 33. The clamp body 31 abuts on the coating portion 12 of the optical fiber strand 10 and presses the optical fiber strand 10 against the V-shaped groove 22. The clamp body 31 is disposed above the V-shaped groove 22. A bottom surface 31a of the clamp body 31 presses the optical fiber strand 10. The bottom surface 31a of the clamp body 31 is, for example, a curved surface protruding downward. The bottom surface 31a in the illustrated example is formed in an arc shape as viewed from the X direction.

The biasing member 33 biases the clamp body 31 toward the V-shaped groove 22. The biasing member 33 may be an elastic body such as a spring. The biasing member 33 as an example is connected to an upper portion of the clamp body 31. The biasing member 33 presses the clamp body 31 downward. The biasing member 33 may be designed such that the force (hereinafter, referred to as a gripping force) for pressing the optical fiber strand 10 disposed in the V-shaped groove 22 is between 2 gf and 14 gf such that the optical fiber strand 10 disposed in the V-shaped groove 22 can move in the axial direction in a state of being pressed by the clamp body 31. The gripping force in this case may be considered as a force by an elastic body such as a spring that presses the clamp body.

The stages 40 (40A and 40B) hold the optical fiber strands 10 at positions on proximal end sides of positions pressed by the clamps 30. The stage 40 as an example includes a holder 45 and a movable stage 41 that holds the holder 45. The holder 45 includes a lower member 42 and an upper member 43, and holds the coating portion of the optical fiber strand 10 by being sandwiched between the lower member 42 and the upper member 43. The movable stage 41 (drive system) holds the holder 45. In addition, the movable stage 41 moves the holder 45 along the axial direction (Y direction in the illustrated example) of the optical fiber strand 10. The stage 40 includes the drive system in the Y direction, and thus, the optical fiber strand 10 can be relatively moved with respect to the clamp 30 and the V-shaped groove 22 to slide on the V-shaped groove 22 with the movement of the holder 45. By the movement of the optical fiber strands 10, an interval between the end surfaces of the glass fibers 11 in the distal end regions of the optical fiber strands 10 pressed against the V-shaped groove 22 by the pair of clamps 30A and 30B can be changed.

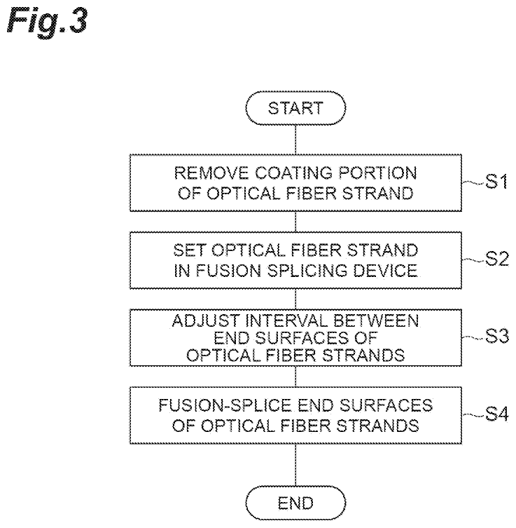

FIG. 3 is a flowchart illustrating an example of a fusion splicing method using the fusion splicing device 1. In the fusion splicing method as an example, first, the coating portion 12 in the distal end region of each optical fiber strand 10 is removed (step S1). The coating portion 12 is removed, and thus, the glass fiber 11 is exposed in the distal end region of the optical fiber strand 10. The length of the exposed glass fiber 11 is not particularly limited, but may be, for example, about 3 mm.

Subsequently, the optical fiber strands 10 are set in the fusion splicing device 1 (step S2). In this step, each of the pair of optical fiber strands 10A and 10B is held by the holders 45 on the movable stages 41. The optical fiber strands 10 are disposed in the V-shaped grooves 22 such that the end surfaces of the exposed glass fibers 11 in the distal end regions face each other. Then, each of the optical fiber strands 10 disposed in the V-shaped grooves 22 is pressed against the V-shaped groove 22 by the clamp 30. In the V-shaped groove 22, the region of the coating portion 12 which is not removed in the optical fiber strand 10 is disposed. In a case where an interval between the pair of V-shaped grooves 22 is 8 mm and the length of the exposed glass fiber 11 is 3 mm, the optical fiber strands 10 are set such that an interval between the pair of glass fibers 11 is 2 mm or less. As described above, the force for pressing the optical fiber strand 10 by the clamp 30 may be 14 gf or less.

Subsequently, the positions of the end surfaces of the glass fibers 11 in the distal end regions are adjusted such that the positions in the X direction and the Z direction of the cores of the optical fiber strands 10 pressed against the V-shaped grooves 22 by the clamps 30 coincide with each other (step S3). In this process, the positions of the end surfaces of the pair of glass fibers 11 in the X-axis direction and the Z-axis direction are controlled by driving the bases 20. In addition, the optical fiber strands 10 slides on the V-shaped grooves 22 by driving the stages 40, and thus, the positions of the optical fiber strands 10 in the Y-axis direction are controlled to have a predetermined end surface interval.

Subsequently, the end surfaces are finally meshed with each other and fusion-connected while the interval between the end surfaces of the glass fibers 11 is adjusted to a predetermined interval (step S4). In this step, for example, arc discharge is performed by an electrode (not illustrated), and thus, the end surfaces of the glass fibers 11 are fusion-spliced.

As described above, the fusion splicing method is a method for fusion-splicing the optical fiber strand 10A in which the outer periphery of the glass fiber 11 is coated with the coating portion 12 to another optical fiber strand 10B. This method includes a step of exposing the glass fiber 11 in the distal end region by removing the coating portion 12 in the distal end region of each optical fiber strand 10, a step of disposing the optical fiber strand 10A in the V-shaped groove 22 (first V-shaped groove) of the base 20A such that the exposed glass fiber 11 in the distal end region of the optical fiber strand 10A faces the end surface of the glass fiber 11 included in the optical fiber strand 10B, a step of pressing the optical fiber strand 10A disposed in the V-shaped groove 22 against the V-shaped groove 22 by the clamp 30, a step of changing the interval between the end surface of the glass fiber 11 in the distal end region of the optical fiber strand 10A pressed against the V-shaped groove 22 by the clamp 30 and the end surface of the glass fiber 11 included in the optical fiber strand 10B, and a step of fusion-splicing the end surfaces to each other. In the step of disposing the optical fiber strand 10A in the V-shaped groove 22, the region of the coating portion 12 that is not removed in the optical fiber strand 10A is disposed in the V-shaped groove 22, and in the step of changing the interval between the end surfaces, the optical fiber strand 10A slides on the V-shaped groove 22.

The fusion splicing device 1 is the device that fusion-splices the optical fiber strand in which the outer periphery of the glass fiber 11 is coated with the coating portion 12 to another optical fiber. This device includes the V-shaped groove 22 (first V-shaped groove) of the base 20A in which the optical fiber strand 10A is disposed, the V-shaped groove 22 (second V-shaped groove) of the base 20B in which the glass fiber 11 included in the optical fiber strand 10B or the optical fiber strand 10B is disposed, and the clamp 30A that presses the optical fiber strand 10A disposed in the V-shaped groove 22 of the base 20A against the groove bottom side. The base 20 moves at least one of the optical fiber strand 10A and the optical fiber strand 10B to change the interval between the end surface of the glass fiber 11 of the optical fiber strand 10A pressed against the V-shaped groove 22 of the base 20A by the clamp 30A and the end surface of the glass fiber 11 included in the optical fiber strand 10B disposed in the V-shaped groove 22 of the base 20B or the end surface of the glass fiber 11 disposed in the V-shaped groove 22 of the base 20B. The optical fiber strand 10A pressed against the V-shaped groove 22 of the base 20A by the clamp 30A is movable to slide with respect to the V-shaped groove 22 of the base 20A.

For example, it is considered that the end surfaces of the pair of glass fibers are meshed with each other by sliding the glass fibers on the V-shaped grooves. In a case where the glass fibers slide on the V-shaped grooves in this manner, it is desirable that the glass fibers slide only in the Y direction. For example, when the coating portion comes into contact with the V-shaped groove, the movement of the glass fibers is hindered, and the glass fibers may also move in the X direction and the Z direction. Therefore, the length of the exposed glass fiber can be set to be longer than or equal to a sum of the length of the V-shaped groove and a moving distance of the glass fiber sliding on the V-shaped groove. On the other hand, when the holder, the V-shaped groove, and the clamp move together with the optical fiber strand as in the technique of Patent Literature 1 described above, the length of the glass fiber exposed at the distal end of the optical fiber strand can be shortened. However, in this case, since the drive system for integrally moving the holder, the V-shaped groove, and the clamp together with the optical fiber strand is required, the manufacturing cost of the device increases.

In the fusion splicing method and the fusion splicing device 1 of the present disclosure, the region of the coating portion 12 in the optical fiber strand 10 from which the glass fiber 11 in the distal end region is exposed is disposed in the V-shaped groove 22, and the optical fiber strand 10 disposed in the V-shaped groove 22 slides to move in the axial direction. Accordingly, the length (that is, the length of the coating portion 12 to be removed) of the exposed glass fiber 11 can be shortened as compared with a case where the glass fiber 11 is disposed in the V-shaped groove 22 and slides. Further, since it is not necessary to move the V-shaped groove 22 and the clamp 30 together with the optical fiber strand 10, it is not necessary to provide the drive system for integrally moving the V-shaped groove and the clamp together with the optical fiber strand 10, and the manufacturing cost of the device can be suppressed.

In an example, the depth of the V-shaped groove 22 may be set to 0.09 mm or more and 0.30 mm or less. In this configuration, in a case where a diameter of the optical fiber strand 10 is about 0.1 mm to 0.25 mm, since the inclined surface 22a constituting the V-shaped groove 22 is in contact with the outer peripheral surface of the optical fiber strand 10 to be the tangential plane, the optical fiber strand 10 is prevented from being caught on the upper end of the inclined surface 22a. In addition, since the outer periphery of the optical fiber strand 10 protrudes from the V-shaped groove 22, the optical fiber strand 10 can be reliably pressed by the clamp 30.

The distance between the V-shaped grooves 22 in which the pair of optical fiber strands 10A and 10B is disposed may be set to 8 mm or more. In this configuration, in a state where the end surfaces of the pair of optical fiber strands 10A and 10B are meshed with each other, since the distance between the coating portions 12 can be appropriately maintained, the coating portions 12 are prevented from being damaged by arc discharge.

In the step of pressing the optical fiber strand 10 against the V-shaped groove 22, the force for pressing the optical fiber strand 10 by the clamp 30 may be 2 gf or more and 14 gf or less. In this configuration, a frictional force generated between the optical fiber strand 10 and the V-shaped groove 22 can be reduced, and the optical fiber strand 10 can appropriately slide on the V-shaped groove 22 while the optical fiber strand 10 is positioned in the V-shaped groove 22.

Although the embodiment of the present disclosure has been described in detail above, the present disclosure is not limited to the above embodiment, and can be applied to various embodiments.

For example, although the example in which the V-shaped groove is formed in the movable base has been described, the V-shaped groove may be formed in a base of which a relative position is fixed.

That is, the fusion splicing device may be a device that performs alignment by a so-called fixed V-shaped groove method.

### REFERENCE SIGNS LIST

1 Fusion splicing device
10 Optical fiber strand
10A Optical fiber strand
10B Optical fiber strand
11 Glass fiber
12 Coating portion
20 Base
20A Base
20B Base
21 Upper end surface
22 V-shaped groove
22a Inclined surface
22b Corner portion
30 Clamp
30A Clamp
30B Clamp
31a Bottom surface
33 Biasing member
40 Stage
40A Stage
40B Stage
41 Movable stage
42 Lower member
43 Upper member
45 Holder
D Depth
L1 Distance
R65 Optical fiber strand
R125 Optical fiber strand
θ Angle

1. A fusion splicing method for an optical fiber for fusion-splicing, with another optical fiber, an optical fiber strand in which an outer periphery of a glass fiber is coated with a coating portion, the method comprising:
a step of exposing the glass fiber in a distal end region of the optical fiber strand by removing the coating portion in the distal end region;
a step of disposing the optical fiber strand in a first V-shaped groove such that an end surface of the exposed glass fiber in the distal end region faces an end surface of a glass fiber included in the other optical fiber;
a step of pressing the optical fiber strand disposed in the first V-shaped groove against the first V-shaped groove by a clamp;
a step of changing an interval between the end surface of the glass fiber in the distal end region of the optical fiber strand pressed against the first V-shaped groove by the clamp and the end surface of the glass fiber included in the other optical fiber; and
a step of fusion-splicing the end surfaces, wherein
in the step of disposing the optical fiber strand in the first V-shaped groove, a region of the coating portion that is not removed in the optical fiber strand is disposed in the first V-shaped groove, and
in the step of changing the interval between the end surfaces, the optical fiber strand slides on the first V-shaped groove.

2. The fusion splicing method for the optical fiber according to claim 1, wherein
a depth of the first V-shaped groove is set to be 0.09 mm or more and 0.30 mm or less.

3. The fusion splicing method for the optical fiber according to claim 1 or 2, wherein
a distance between the first V-shaped groove and a second V-shaped groove in which the glass fiber included in the other optical fiber or the other optical fiber is disposed is set to be 8 mm or more.

4. The fusion splicing method for the optical fiber according to any one of claims 1 to 3, wherein
in the step of pressing the optical fiber strand against the first V-shaped groove, a force for pressing the optical fiber strand by the clamp is 2 gf or more and 14 gf or less.

5. A fusion splicing device for a optical fiber for fusion-splicing, with another optical fiber, an optical fiber strand in which an outer periphery of a glass fiber is covered with a coating portion, the device comprising:
a first V-shaped groove in which the optical fiber strand is disposed;
a second V-shaped groove in which a glass fiber included in the other optical fiber or the other optical fiber is disposed;
a clamp configured to press the optical fiber strand disposed in the first V-shaped groove against a groove bottom side; and
a stage configured to move at least one of the optical fiber strand or the other optical fiber such that an interval between an end surface of the glass fiber of the optical fiber strand pressed against the first V-shaped groove by the clamp and an end surface of the glass fiber included in the other optical fiber disposed in the second V-shaped groove or an end surface of the glass fiber disposed in the second V-shaped groove is changed, wherein
the optical fiber strand pressed against the first V-shaped groove by the clamp is movable to slide on the first V-shaped groove.
